(19) United States
(12) Patent Application Publication
(10) Pub. No.: US 2014/0079400 A1
(43) Pub. Date: Mar. 20, 2014

(54) FIBER OPTIC DATA NETWORKS THAT SIMULTANEOUSLY CARRY NETWORK DATA AND CONTROL SIGNALS OVER THE SAME FIBER OPTIC LINKS AND RELATED METHODS AND APPARATUS

(71) Applicant: CommScope, Inc. of North Carolina, Hickory, NC (US)

(72) Inventor: Abhijit I. Sengupta, Alpharetta, GA (US)

(21) Appl. No.: 13/975,529

(22) Filed: Aug. 26, 2013

Related U.S. Application Data
(60) Provisional application No. 61/702,836, filed on Sep. 19, 2012.

(51) Int. Cl. H04J 14/02

(52) U.S. Cl. CPC H04J 14/0278
USPC 398/79

(57) ABSTRACT

Fiber optic data networks have a first network device that has a first optical transmitter that is configured to transmit an optical signal having a first wavelength. A fiber optic communications channel provides a data connection between the first network device and a second network device. The network further includes a second optical transmitter that is configured to transmit an optical signal having a second wavelength that is different from the first wavelength. A coupling device is provided that is configured to inject the signal having the second wavelength that is output by the second optical transmitter onto the fiber optic communications channel. These fiber optic data networks may carry control data in real time on the same optical fibers that are used to carry the normal network traffic.

### CROSS REFERENCE TO RELATED APPLICATIONS

This application claims priority under 35 U.S.C. §119 to U.S. Provisional Patent Application No. 61/702,836, filed Sep. 19, 2012, the entire disclosure of which is hereby incorporated herein by reference.

### FIELD OF THE INVENTION

The present invention relates to fiber optic communications and, more particularly, to fiber optic data networks that support the transmission of both high data rate network traffic and typically lower data rate fiber optic control signals.

### BACKGROUND

A fiber optic data network refers to a network of interconnected devices that transmit information (data) to each other over optical fiber communications links. Fiber optic data networks are presently being deployed in an increasing number of applications given the high data rates that can be transmitted over optical fibers and the decreasing cost of fiber optic cables and apparatus. By way of example, fiber optic data networks are now routinely used in data centers, skyscrapers, office buildings, sports arenas, aircraft, ships, shopping malls and the like to facilitate high speed data transfer between devices.

In many cases, it may be desirable to monitor or control the equipment and/or infrastructure that is part of or associated with a fiber optic data network and/or to monitor or control devices that are interconnected via the fiber optic data network. It may also be desirable to monitor or control equipment that is located close enough to a fiber optic data network to be accessible via the fiber optic data network. However, communicating the monitoring and control data between centralized controllers and the remote nodes of a fiber optic network may require the deployment of additional network infrastructure which can increase the cost of deploying a fiber optic data network.

### SUMMARY

Pursuant to embodiments of the present invention, fiber optic data networks are provided that include a first network device that has a first optical transmitter that is configured to transmit an optical signal having a first wavelength and a second network device. The data network further includes a fiber optic communications channel that provides a data connection between the first network device and the second network device. A second optical transmitter is included in the network that is configured to transmit an optical signal having a second wavelength that is different from the first wavelength. A coupling device is provided that is configured to inject the signal having the second wavelength that is output by the second optical transmitter onto the fiber optic communications channel.

In some embodiments, the coupling device may be a first wave division multiplexer. The fiber optic data network may also include a second wave division multiplexer that is remote from the first wave division multiplexer and that is configured to inject an optical control signal onto the fiber optic communications channel. The fiber optic data network may also include a backscatter device that is tuned to the second wavelength and a backscatter device actuator such as, for example, an ultrasonic acoustic modulator, that is configured to selectively activate the backscatter device so as to selectively reflect a portion of the optical signal having the second wavelength. In such embodiments, the backscatter device actuator may be configured to generate an amplitude modulated control signal by causing the backscatter device to selectively reflect the portion of the optical signal having the second wavelength. The fiber optic data network may also include a second wave division multiplexer that is interposed on the fiber optic communications channel and a receiver that is coupled to an output of the second wave division multiplexer.

In some embodiments, the fiber optic data network may further include a wavelength converter that is configured to generate an optical signal at a third wavelength that is different than the second wavelength, a backscatter device that is tuned to the third wavelength and a backscatter device actuator that is configured to selectively activate the backscatter device so as to selectively reflect at least a portion of the optical signal at the third wavelength. In such embodiments, the backscatter device actuator may be configured to generate an amplitude modulated control signal by causing the backscatter device to selectively reflect at least a portion of the optical signal at the third wavelength. The third wavelength may be a second harmonic of the second wavelength.

In some embodiments, the first wavelength and the second wavelength may be separated by at least 50 nanometers. The optical signal having the second wavelength may comprise an optical control signal such as a control signal that includes sensor data. In some embodiments, the backscatter device may be a grating, and the backscatter device actuator may be a device that selectively imparts a stress on the grating that tunes the grating to reflect signals at the second wavelength.

Pursuant to embodiments of the present invention, methods of communicating over a communications channel that includes one or more optical fibers are provided in which a first optical signal that has a first wavelength is transmitted from a first network device to a second network device over the communications channel. A second optical signal that has a second wavelength that is different from the first wavelength is coupled onto the communications channel. A portion of the second optical signal is reflected using a backscatter device to generate an optical control signal that is transmitted along the optical fiber simultaneously with the first optical signal.

In some embodiments, the backscatter device actuator may be used to selectively activate the backscatter device so as to amplitude modulate the optical control signal. Additionally, a wave division multiplexer may be used in some embodiments to extract the optical control signal from the communications channel.

Pursuant to embodiments of the present invention, methods of communicating over a communications channel are provided in which an optical data signal that has a first wavelength is transmitted from a first network device to a second network device over the fiber optic communications channel. A portion of the optical data signal is reflected using a backscatter device actuator to generate an optical control signal that is transmitted along the fiber optic communications channel simultaneously with the optical data signal. The optical control signal is coupled from the fiber optic communications channel to an optical receiver using an optical circulator that is interposed along the fiber optic communications channel.

In some embodiments, the backscatter device actuator may be used to selectively stress the fiber optic communications channel in order to reflect the optical data signal in a manner that amplitude modulates the optical control signal. In some embodiments, the backscatter device may be a piezoelectric device or a MEMS device.

Pursuant to still further embodiments of the present invention, fiber optic data networks are provided that include a first network device that has an optical transmitter that is configured to transmit an optical signal, a second network device, and a fiber optic communications channel that provides a data connection between the first network device and the second network device. These networks further include a backscatter device actuator that is configured to selectively stress the fiber optic communications channel in order to reflect a portion of the optical signal, an optical receiver, and an optical circulator that is configured to pass the optical signal from the optical transmitter to the fiber optic communications channel and to pass the reflected portion of the optical signal from the fiber optic communications channel to the optical receiver.

### BRIEF DESCRIPTION OF THE DRAWINGS

FIG. 1 is a schematic block diagram of a portion of a fiber optic data network according to certain embodiments of the present invention.

FIG. 2 is a schematic block diagram of a portion of a fiber optic data network according to further embodiments of the present invention.

FIG. 3 is a schematic block diagram of a portion of a fiber optic data network according to yet additional embodiments of the present invention.

FIG. 4 is a schematic block diagram of a portion of a fiber optic data network according to still further embodiments of the present invention.

FIG. 5 is a schematic block diagram of a fiber optic data network according to certain embodiments of the present invention.

FIG. 6 is a schematic diagram of a highly simplified fiber optic data network that includes intelligent patching capabilities according to embodiments of the present invention.

FIG. 7 is an enlarged schematic block diagram of one of the fiber optic patch panels included in the fiber optic data network of FIG. 6.

FIG. 8 is a flow chart illustrating methods of automatically tracking patching connections in a fiber optic data network according to certain embodiments of the present invention.

FIG. 9 is a flow chart illustrating methods of simultaneously transmitting control signals and network data over a communications channel of a fiber optic data network according to certain embodiments of the present invention.

### DETAILED DESCRIPTION

Pursuant to embodiments of the present invention, fiber optic data networks are disclosed that may simultaneously carry high data rate network traffic between various of the devices that are interconnected by the network while, at the same time, using the same optical fibers that carry the high data rate network traffic to communicate control signals over the fiber optic data network. As the control signals are transmitted over the same cabling that carries the network data traffic, the cost of providing the control capabilities may be significantly decreased. Moreover, the networks according to embodiments of the present invention may carry these control signals without significantly impacting or disrupting the high speed network data traffic, and may thus allow, for example, real time monitoring and control of equipment over the fiber optic data network. Herein the term “control signal” is used broadly to refer to any signal that is used for control purposes, without limitation, including, for example, command signals, interrogation signals, response signals, and signals containing control data such as status data, monitoring data, sensor data and the like. These control signals may be carried in real time over the fiber optic data network,

According to some embodiments of the present invention, multi-mode interference (“MMI”) wave division multiplex (“WDM”) filters (referred to herein as “MMI-WDM filters”) may be provided that may be used to inject optical control signals onto the optical fibers of an underlying fiber optic data network and/or to extract such optical control signals from the optical fibers of the underlying fiber optic data network. An MMI-WDM filter may be provided at each node in the fiber optic data network where control data is to be injected or extracted. These fiber optic control signals may be transmitted using an optical source that transmits at a first wavelength while the underlying network data that is carried by the fiber optic data network may be transmitted at a second wavelength that is different than the first wavelength. In some embodiments, the first and second wavelengths may be widely separated. For example, the second wavelength may be about 850 nm, while the first wavelength may be about 600-650 nm or about 1310 nm. By selecting first and second wavelengths that are widely separated from each other, it may be possible to use relatively simple, low cost MMI-WDM filters to inject and extract the fiber optic control signals.

Pursuant to further embodiments of the present invention, modulation reflectometry techniques may alternatively be used to inject optical control signals onto the optical fibers of an underlying fiber optic data network. Pursuant to these techniques, an optical circulator may be installed on a fiber optic communications channel at a centralized location where the fiber optic control data is to be extracted from the channel. Backscatter device actuators such as acoustic modulators, piezoelectric devices or the like may be positioned along other portions of the fiber optics communications channel where fiber optic control signals are to be injected onto the channel. These backscatter device actuators may be used to stretch or bend the optical fiber in a controlled manner in order to generate a reflected or “backscattered” optical signal that travels in the opposite direction along the optical fiber to the centralized location, where it is extracted using the optical circulator. Herein, a “backscatter device actuator” refers to a device that may be used to activate either a “backscatter device” (backscatter devices are discussed below) or an optical transmission medium such as an optical fiber so that at least a portion of an optical signal that is being transmitted through the backscatter device or along the optical transmission medium is reflected back in the opposite direction toward the optical source. In some embodiments, these backscatter device actuators may be used to selectively activate the backscatter device or the optical transmission medium in order to generate a low frequency amplitude modulated reflected signal that is imposed on the high speed network data.

Pursuant to still further embodiments of the present invention, a combination of MMI-WDM filters and modulation reflectometry techniques may be used to inject and extract optical control signals onto/from the optical fibers of an underlying fiber optic data network. Pursuant to these techniques, MMI-WDM filters may be used to inject and extract optical control signals onto a fiber optic communications channel, while backscatter devices may be provided at various nodes along the communications channel that are used to generate, for example, responsive control signals. Herein, a “backscatter device” refers to a device or element that receives an incident optical signal having a first wavelength, where the device/element has a first position or state in which it reflects at least a portion of the incident optical signal back in the opposite direction toward the optical source and that has a second position or state in which it substantially allows the incident optical signal to pass through without reflection. In some embodiments, the backscatter devices may be implemented using gratings that can be activated or “tuned” to be in the first position/state in which they reflect at least a portion of an incident optical signal having a first wavelength and that otherwise are in the second position/state in which they substantially allow the incident optical signal having the first wavelength to pass through without reflection. Backscatter device actuators may also be provided at the various nodes along the communications channel that may be used to selectively activate the respective backscatter devices. As noted above, these backscatter device actuators may comprise, for example, acoustic modulators, piezoelectric devices or mechanical or electro-mechanical devices such as vibrators that are used to selectively activate the backscatter device so as to generate an amplitude modulated reflected control signal. This approach allows for the transmission of control signals in both directions along the fiber optic communications channel (e.g., both interrogation signals and data returned in response thereto).

Pursuant to yet additional embodiments of the present invention, the optical control signals may be generated at wavelengths that are different than the wavelengths of the other optical signals that are carried on the channel. These embodiments may be similar to the above-described embodiments that use a combination of MMI-WDM filters and modulation reflectometry techniques to inject and extract the fiber optic control signals, except that a wavelength converter is also provided that is used to generate an optical signal that is at a different wavelength than the wavelengths of optical signals that are passing along the communications channel. Herein, a wavelength converter refers to an element or device that receives an incident optical signal and converts at least part of that optical signal to a converted optical signal having a different wavelength. Backscatter devices and backscatter device actuators may then be used to generate an optical control signal by selectively reflecting the converted optical signal. This approach also allows for the transmission of control signals in both directions along the fiber optic communications channel.

Embodiments of the present invention will now be discussed with reference to the attached drawings, in which certain embodiments of the present invention are shown.

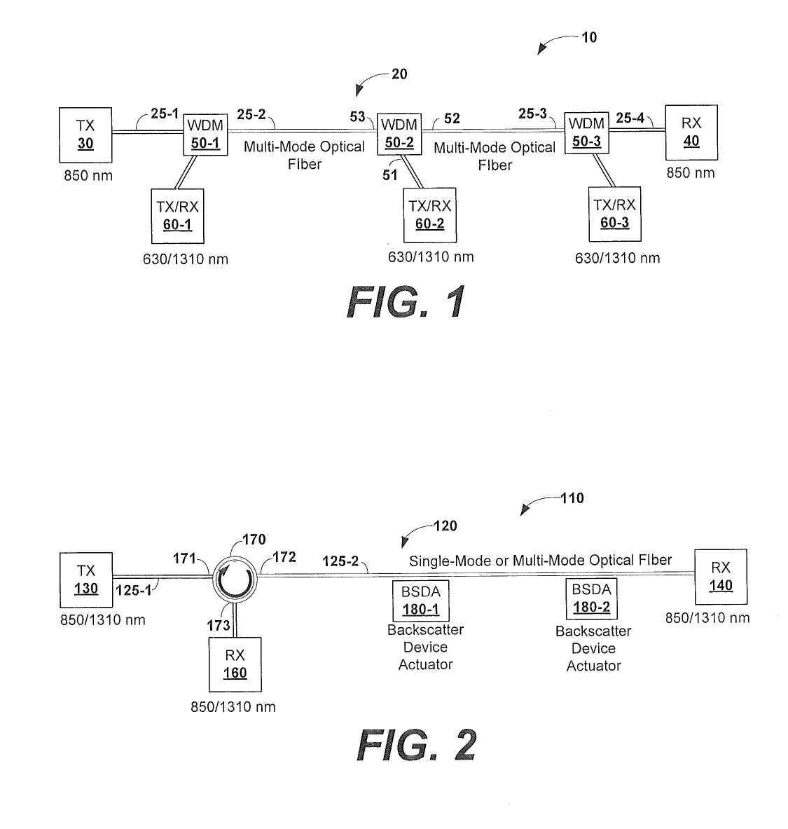

FIG. 1 is a schematic block diagram of a communications channel 20 of a fiber optic data network 10 that illustrates how MMI-WDM filters 50 may be used to inject optical control signals onto the communications channel 20 and to extract these optical control signals from the communications channel 20.

Referring to FIG. 1, the fiber optic data network 10 may include a large number of fiber optic communications channels 20, only one of which is illustrated in FIG. 1 in order to simplify the drawing. The fiber optic communications channel 20 may comprise, for example, a plurality of optical fibers 25-1 through 25-4 that are interconnected in such a way that an optical signal may be injected at one end of the communications channel 20 and extracted at the opposite end of the channel 20. Herein, when a plurality of devices (e.g., an optical fiber) that have the same general structure are depicted in the drawings, these devices will be referred o individually in the text by their complete reference numeral (e.g., optical fiber 25-2 or optical fiber 25-4), and may be referred to collectively in the text by the base portion of their reference numeral (e.g., the optical fibers 25). At least some of the optical fibers 25-1 through 25-4 may be contained within respective fiber optic cables (not shown). At least some of the various optical fibers 25-1 through 25-4 may be interconnected using fiber optic connectors such as fiber optic adapters (not shown) that may comprise individual connectors or which may be part of patch panels, fiber optic shelves and the like and by other fiber optic elements such as optical circulators, optical filters, etc. The illustrated communications channel 20 further includes a first optical transmitter 30 at one end thereof that injects normal network traffic onto the communications channel 20, and an optical receiver 40 that may be located, for example, at the end of the fiber optic communications channel 20 that is opposite the first optical transmitter 30.

The optical transmitter 30 may be any suitable source for generating an optical signal including, for example, a semiconductor laser, a semiconductor light emitting diode (“LED”), an organic LED and the like. The optical transmitter 30 may be directly connected to the optical fiber 25-1 or, alternatively, may be connected to the optical fiber 25-1 via another optical transmission path (not shown) such as a waveguide.

As is further shown in FIG. 1, a plurality of MMI-WDM filters 50-1 through 50-3 are interposed along the fiber optic communications channel 20. In particular, an MMI-WDM filter 50 may be provided at each location where control signals are to be injected onto, or extracted from, the communications channel 20. As known to those of skill in the art, an MMI WDM filter may be implemented as a three port device having a common port, a low wavelength port and a high wavelength port. The common port may, for example, pass optical signals of any wavelength, while the low wavelength port will pass optical signals having a wavelength below a certain cut-off wavelength while substantially attenuating (i.e., not passing) optical signals having wavelengths above the cut-off wavelength. The high wavelength port will pass optical signals having a wavelength that is above the cut-off wavelength, while substantially attenuating (i.e., not passing) optical signals having wavelengths that are below the cut-off wavelength. It will be appreciated that the cut-off wavelength may actually be a range of wavelengths because the filtering characteristics of the MMI-WDM may partially pass optical signals at wavelengths that are close to the cut-off wavelength through either or both the low wavelength port and the high wavelength port. MMI-WDM filters are commercially available, and may be relatively inexpensive if they are designed to separate optical signals having two wavelengths that are relatively far apart such as two wavelengths that are at least 50 nm apart or, more preferably, at least 100 nm apart.

As shown with respect to MMI-WDM filter 50-2 in FIG. 1, each of the MMI WDM filters 50 may have a control signal port 51 (i.e., a port that only passes the control signals), a data signal port 52 (i.e., a port that only passes the data signals) and a common port 53 (i.e., a port that passes both the data signals and the control signals). As shown in FIG. 1, control signal optical transceivers 60-1 through 60-3 may be attached to the control signal ports 51 of MMI-WDM filters 50-1 through 50-3, respectively. The optical transceiver 60-1 may be located at a centralized location or otherwise be in communication with a control computer or other controller (not shown). The optical transceiver 60-1 may generate and transmit interrogation signals that request control data from the optical transceivers 60-2 and 60-3. The optical transceiver 60-1 also receives control signals that are forwarded by the optical transceivers 60-2 and 60-3. In some embodiments, each optical transceiver 60 may only engage in one-way communications (i.e., optical transceivers 60-2 and 60-3 only transmit control signals and do not receive any control signals, while optical transceiver 60-1 only receives control signals, and does not transmit any control signals), while in other embodiments some or all of the optical transceivers 60 may engage in two way communications. The optical transmitter 60-1 may be any suitable source for generating an optical signal including, for example, a semiconductor laser, a semiconductor LED, an organic LED or the like.

In some embodiments of the present invention, the optical transmitter 30 may transmit optical signals having a wavelength of about 850 nm, and the optical fibers 25-1 through 25-4 may comprise multi-mode optical fibers when being used as a communications medium for 850 nm signals. In such embodiments, the optical receiver 40 may be designed to receive 850 nm optical signals. In such embodiments, the optical transceivers 60-1 through 60-3 may be configured to generate, for example, 1310 nm optical control signals using, for example, conventional single mode optical transmitters. In such an embodiment, the network data signals are widely separated in wavelength from the optical data signals (i.e., by 460 nm), thereby allowing the use of low-cost MMI-WDM filters. In such embodiments, it is anticipated that MMI-WDM filters may be designed that would achieve reflection isolation of greater than 25 dB and transmission losses as low as less than 0.1 dB. However, it will be appreciated that the network data and/or the optical control signals could be transmitted at a wide variety of different wavelengths, with the only limitation being that the MMI-WDM filters 50 be able to sufficiently separate the network data from the optical control signals. Accordingly, this embodiment of the present invention is not limited to the example wavelengths discussed above. As another example, the optical control signals could be transmitted at wavelengths in the range of about 600-650 nm. Such optical control signals could be generated, for example, using a red laser or a red LED. It will also be appreciated that the network data signals and/or the optical control signals may pass along the communications channel 20 as either multi-mode signals, single-mode signals or as few-mode signals, and that any sized optical fibers may be used to form the communications channel 20.

MMI-WDM filters are currently commercially available that filter, for example, between 630 nm and 850 nm optical signals, between 850 nm and 1310 nm optical signals, and between 1310 nm and 1550 nm optical signals, and these MMI-WDM filters may be used to implement the communications channel 20 illustrated in FIG. 1. Moreover, pursuant to further embodiments of the present invention, compact MMI-WDM filters 50 may be developed using silicon photonic technology that may be very low cost filters, so that it will easily be commercially practical to include a plurality of MMI-WDM filters 50 on the communications channel 20 of fiber optic data network 10 to allow for the transmission of control signals over the communications channel 20.

By adding the MMI-WDM filters 50 and the optical transceivers 60 to the communications channel 20, it becomes possible to use the communications channel 20 to support both the underlying network data traffic while simultaneously using the communications channel 20 to carry control data to, for example, a centralized location. As will be discussed in more detail herein, the control signals may include a wide variety of control data including, for example, command signals, interrogation signals, response signals, and signals containing control data such as status data, monitoring data, sensor data and the like.

FIG. 2 is a schematic block diagram of a communications channel 120 of a fiber optic data network 110 that illustrates how an optical circulator 170 and a plurality of backscatter device actuators 180 may be used to inject optical control signals onto the communications channel 120 and to extract these optical control signals from the communications channel 120.

The fiber optic data network 110 may include a large number of fiber optic communications channels 120, only one of which is illustrated in FIG. 2 in order to simplify the drawing. The fiber optic communications channel 120 may comprise, for example, a plurality of optical fibers 125-1 through 125-2. The illustrated communications channel 120 further includes a first optical transmitter 130 at one end thereof that injects normal network traffic onto the communications channel 120, and an optical receiver 140 that may be located, for example, at the end of the fiber optic communications channel 120 that is opposite the first optical transmitter 130. In the depicted embodiment, the first optical transmitter 130 is configured to generate, for example, either an 850 nm optical signal that may travel along the fiber optic communications channel 20 as a multi-mode signal or a 1310 nm optical signal that may travel along the fiber optic communications channel 120 as a single-mode signal.

The communications channel 120 further includes an optical circulator 170 that is interposed between the first optical fiber 125-1 and the second optical fiber 125-2. Optical circulators are known in the art, and operate to allow a signal that enters at one port thereof to flow in a specified direction and then exit the optical circulator at the next port. For example, the optical circulator 170 that is illustrated in FIG. 2 includes three ports 171-173, and is designed to circulate optical signals input thereto in the clockwise direction. Consequently, optical signals that are received at port 171 from the first optical fiber 125-1 travel in the clockwise direction through optical circulator 170 until they reach port 172, where the optical signals are then output to the second optical fiber 125-2. Similarly, optical signals that are input to the optical circulator 170 at port 172 from the second optical fiber 125-2 travel in the clockwise direction through optical circulator 170 until they reach port 173 where the optical signals are then output to a control signal optical receiver 160.

As shown in FIG. 2, the optical circulator 170 and the control signal optical receiver may be located, for example, at a centralized location where control data is gathered or may otherwise be in communication with a control computer or other controller (not shown). As optical circulators are commercially available for both 1310 nm single mode applications and 850 nm multi-mode applications, the communications channel 120 may comprise either type of channel (or some other type of channel). Optical circulators may have very low transmission losses (e.g., less than 0.1 dB). Thus, the optical circulator 170 may provide a convenient mechanism for extracting optical control signals at, for example, a centralized location.

As is further shown in FIG. 2, one or more backscatter device actuators 180-1 and 180-2 may be provided at selected locations along the communications channel 120. As noted above, the backscatter device actuators 180 may comprise devices that are configured to selectively compress, stretch or bend the optical fiber 125-2 in order to partially backscatter optical signals that are passing therethrough in a first direction (which here is from the optical transmitter 130 to the optical receiver 140) in a manner that will generate a reflected signal that passes along the optical fiber 125-2 in the opposite direction (i.e., back towards the optical circulator 170). In some embodiments, the backscatter device actuators 180 may be implemented as, for example, a battery-powered ultrasonic acoustic wave generator 180 that includes a piezoelectric material that generates an ultrasonic acoustic wave in response to an electrical control signal. Each ultrasonic acoustic wave generator 180 may be positioned adjacent to the optical fiber 125-2 (or a cable that the optical fiber 125-2 is enclosed in) or otherwise located so that the device may selectively compress, stretch or bend the optical fiber 125-2 so as to reflect part of an optical signal that is passing through the optical fiber 125-2. In some example embodiments, each ultrasonic acoustic wave generator 180 may be wrapped around the optical fiber 125-2. In other example embodiments, the optical fiber 125-2 may be wrapped around each ultrasonic acoustic wave generator 180. Numerous other configurations are possible. Moreover, while an ultrasonic acoustic generator 180 represents one possible implementation of the backscatter device actuators 180 that may be used in embodiments of the present invention, it will be appreciated that in other embodiments the backscatter device actuators 180 may be implemented using other acoustic or piezoelectric devices, vibrators, micro electro-mechanical (“MEMS”) devices or any other appropriate device that may compress, stretch, bend or otherwise move the optical fiber 125-2 in a manner that backscatters (i.e., reflects) a portion of an optical signal that is passing along the optical fiber 125-2.

The backscatter device actuators 180 may be configured to vibrate in a low frequency range (e.g., in the kilohertz frequency range) so as to generate a low frequency modulation backscatter optical signal (which may also be referred to herein as a “reflected” optical signal) that is imposed on the high speed network data. This backscattered signal may comprise a control signal that is used to carry control data from various nodes along the optical fiber 125-2 to, for example, a centralized location via the optical circulator 170. The backscatter device actuators 180 may selectively compress, stretch or bend the optical fiber in such a way that an amplitude modulated backscattered optical control signal is generated that has the control data embedded therein. For example, the backscatter device actuators 180 may selectively move the optical fiber 125-2 to generate a series of reflected signals. A frequency of the optical control signal may be predetermined. Accordingly, at the optical receiver 160, the presence of a reflected signal may, for example, be interpreted as data “1” while the absence of a reflected signal may be interpreted as data “0.” In this fashion, by selectively controlling a backscatter device actuator 180 to either move or not move the optical fiber 125-2, an amplitude modulated optical control signal having control data embedded therein may be injected onto the optical fiber 125-2. Notably, this approach avoids any need to inject an optical control signal from a separate optical source onto the optical fiber 125-2, and also does not require the use of optical signals that are at different wavelengths.

In some embodiments, very little power may be required to generate the modulated backscattered optical control signals, as very low power ultrasonic acoustic wave generators 180 may be used given the very small distances that the optical fiber 125-2 must be moved in order to generate reflection losses on a high speed optical data signal that is travelling along the optical fiber 125-2. Additionally, as a low frequency amplitude modulation technique may be used, it is expected that inexpensive acoustic modulators may be used to generate the backscattered optical control signals.

It will be appreciated that, when backscatter techniques are used to generate the optical control signals, such control signals may only be generated so long as an optical signal (e.g., carrying network data traffic) is present on the optical fiber 125-2. Thus, in some embodiments, the optical source 130 may always transmit a signal along the optical fibers 125-1 and 125-2, even during times when no network data is present, to ensure that optical control signals may be generated at any time.

The backscatter device actuators 180 may be configured to move the optical fiber 125-2 in a manner that does not significantly impact the high frequency optical network data signal. Instead, the backscatter device actuators 180 may, in effect, introduce a slow jitter on the high frequency optical network data signal. If the high frequency optical network data signal travels along the optical fiber 125-2 as a multi-mode signal, the modulation by the backscatter device actuators 180 may primarily impact the higher modes of the multi-mode signal, which may decrease the impact on the high frequency optical network data signal. It is anticipated that in some embodiments the loss to the high frequency optical network data signal caused by the generation of the amplitude modulated optical control signal may be on the order of 0.5 dB or less, and this loss is not a continuous loss, as typically the backscattered optical control signal will only be transmitted intermittently.

The backscattered signal may be very weak in terms of intensity, as only a small portion of the high frequency optical network data signal may be reflected back down the optical fiber in the opposite direction. Accordingly, a relatively sensitive optical receiver 160 may be used in order to ensure proper detection of the backscattered optical control signals. In some embodiments, the optical receiver 160 may use heterodyne optical detection that zones in on the particular frequency of interest. Alternatively, the optical receiver 160 may convert the optical control signal to an electrical signal and then low pass filter the electrical signal and perform heterodyne detection on the signal that passes through the low pass filter.

As multiple backscatter device actuators 180 may be provided along the optical fiber 125-2, it may be desirable to provide mechanisms for identifying at the optical receiver 160 which particular backscatter device actuator 180 transmitted each received optical control signal. In some embodiments, this may be accomplished by configuring each backscatter device actuator 180 to generate an optical control signal that is at a slightly different frequency. The optical receiver 160 may be configured to detect the frequency of each received optical control signal, and then compare that received frequency to pre-stored information that associates each backscatter device actuator 180 with a particular frequency optical control signal. In other embodiments, each backscatter device actuator 180 may have an associated unique identifier (or, alternatively, other equipment that transmits control data via the backscatter device actuator 180 may have such a unique identifier), and this unique identifier may be transmitted as part of the data included in each optical control signal in order to allow the source of each optical control signal to be identified. In still other embodiments, time domain reflectometry or other similar techniques may be used to identify which backscatter device actuator 180 generated each optical control signal. Pursuant to these techniques, “signatures” may be generated for each backscatter device actuator 180 that are stored at, for example, the centralized location. Typically, based on the different lengths that the optical control signals will pass along the optical fiber 125-2 and various other factors, the time or frequency domain response of the received optical control signal will differ depending upon which backscatter device actuator 180 was used to generate the optical control signal. Each received optical control signal may be compared to the stored “signatures” for each backscatter device actuator 180 to identify the backscatter device actuator 180 that generated the optical control signal at issue. Other techniques for determining which backscatter device actuator 180 generated a particular optical control signal may also be used.

It will also be appreciated that more than one of the backscatter device actuators 180 may transmit optical control signals at the same time. If this occurs, the multiple optical control signals may interfere with each other. In some embodiments, all of the backscatter device actuators 180 on a particular communications channel 120 may be assigned different time slots for transmitting optical control signals, and this time division multiplexing approach may be used to avoid interference (and may also be used to identify the particular backscatter device actuator 180 that generated each optical control signal). In other embodiments, occasional lost optical control signals due to such interference may be acceptable and hence tolerated (e.g., in embodiments when optical control signals are transmitted every few second or minutes that update sensor data such that an occasional loss of this data is unimportant).

In the embodiment of FIG. 2, the optical circulator 170 allows the 850 or 1310 nm optical signal that is transmitted by the first optical transmitter 130 to pass from port 171 to port 172, and this optical signal then proceeds along the optical fiber 125-2 to the backscatter device 180-1 (and beyond). Notably, the optical signal that is passed from the first optical transmitter 130 to the optical circulator 170 is not passed to port 173 of the optical circulator 170. As such, the only optical signal that is received at the optical receiver 160 is the reflected optical signal generated by, for example, the backscatter device 180-1. Consequently, the signal-to-noise ratio at the receiver 160 may be significantly improved. Additionally, since the reflected optical signal will only travel from port 172 to port 173 of the optical circulator 170, feedback of the reflected signal to the optical transmitter 130 may also be avoided.

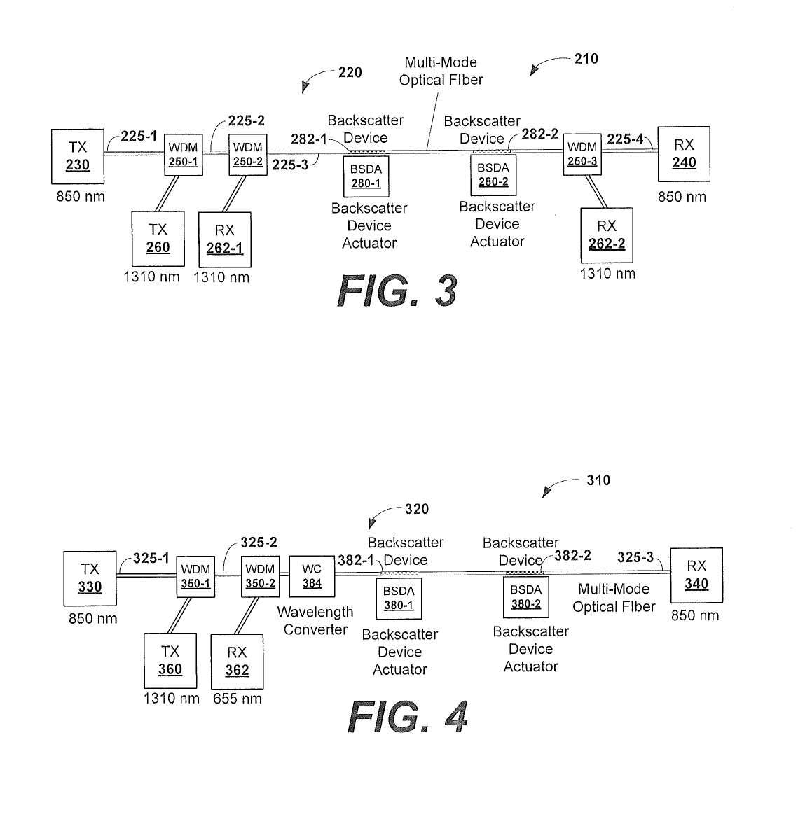

FIG. 3 is a schematic block diagram of a communications channel 220 of a fiber optic data network 210 according to still further embodiments of the present invention. The embodiment of FIG. 3 combines various aspects of the embodiments of FIGS. 1 and 2 that are described above.

In particular, the fiber optic communications channel 220 may comprise, for example, a plurality of optical fibers 225-1 through 225-4. The communications channel 220 includes a first optical transmitter 230 at one end thereof that injects normal network traffic data signals onto the communications channel 220, and an optical receiver 240 that may be located, for example, at the end of the fiber optic communications channel 220 that is opposite the first optical transmitter 230. In the depicted embodiment, the first optical transmitter 230 is configured to generate, for example, an 850 nm optical signal that may travel along the fiber optic communications channel 220 as a multi-mode signal.

A plurality of MMI-WDM filters 250-1 through 250-3 are interposed along the fiber optic communications channel 220. In particular, a first MMI-WDM filter 250-1 may be provided at, for example, a centralized location that may be used to inject optical control signals having a first wavelength (1310 nm, in the example of FIG. 3) onto the communications channel 220. A second MMI-WDM filter 250-2 may also be provided at, for example, the centralized location that may be used to extract optical control signals having the first wavelength (1310 nm, in the example of FIG. 3) from the communications channel 220. Finally, a third MMI-WDM filter 250-3 may be provided at a different location that may be used to extract control signals having the first wavelength (1310 nm, in the example of FIG. 3) from the communications channel 220. Each of the MMI-WDM filters 250 may be identical to the MMI-WDM filters 50 that are described in more detail above with respect to FIG. 1, and hence further description of the MMI-WDM filters 250 will be omitted. In the embodiment depicted in FIG. 3, each MMI-WDM filter 250 has an 850 nm port (for injecting or extracting the high frequency network data traffic), a 1310 nm port (for injecting or extracting the optical control signals) and a common port that passes both the 850 nm and 1310 nm optical signals. It will be appreciated that any appropriate pair of wavelengths may be used, and thus embodiments of the present invention are not limited to the example wavelengths depicted in FIG. 3.

As is also shown in FIG. 3, a control signal optical transmitter 260 may be attached to the control signal port of the first MMI-WDM filter 250-1, and control signal optical receivers 262-1 and 262-2 may be attached to the control signal port of the second and third MMI-WDM filters 250-2 and 250-3, respectively. The optical transmitter 260 may be located at, for example, a centralized location and may be used to, among other things, inject interrogation signals, equipment control signals and the like onto the communications channel 220. The optical receiver 262-1 may receive optical control signals that are communicated in the reverse direction along the communications channel 220. The optical receiver 262-2 may receive the interrogation signals, equipment control signals and the like that are transmitted by the optical transmitter 260. Additional optical receivers 262 may be interposed at additional locations along the communications channel 220 as needed.

The optical fiber 250-3 may include backscatter devices 282-1 and 282-2 that are built into or interposed along the optical fiber 250-3. As noted above, a backscatter device refers to a device or element that has a first position or state in which it reflects at least a portion of an incident optical signal that has a first wavelength back in the opposite direction toward the optical source and a second position or state in which it substantially allows the incident optical signal having the first wavelength to pass through without reflection. In some embodiments, the backscatter devices 282-1 and 282-2 may comprise respective gratings 282-1 and 282-2 that are built into the optical fiber 250-3. These gratings 282 may be “tuned” to the wavelength of the signals that are transmitted by the optical transmitter 260. For example, in the particular embodiment depicted in the example of FIG. 3, the optical transmitter 260 transmits a 1310 nm optical control signal, while the optical transmitter 230 transmits 850 nm optical signals. The gratings 282 may be configured so that in a first position they allow 1310 nm signals that are present on the optical fiber 225-3 to pass without any substantial reflections, while in a second position, they act to partially reflect 1310 nm signals that are passing over the optical fiber 225-3. In light of the large wavelength separation between the 850 nm network traffic signals and the 1310 nm control signals, the gratings 282 may be designed to substantially pass 850 mu optical signals when the gratings 282 are in either the first or second positions. Thus, the gratings 282 may be used to selectively reflect a portion of a 1310 nm optical signal that is passing along the optical fiber 225-3.

As is further shown in FIG. 3, a plurality of backscatter device actuators 280-1 and 280-2 are also provided at selected locations along the communications channel 220. The backscatter device actuators 280 are configured to, for example, stretch, contract, bend or otherwise move the respective gratings 282-1 and 282-2 in order to switch the gratings 282 between their respective first and second positions/states. The backscatter device actuators 280-1 and 280-2 may thus be used to inject an amplitude modulated control signal onto the optical fiber 225-3 by selectively moving/stressing the respective gratings 282-1 and 282-2, respectively, between their first and second positions/states. For example, backscatter device actuator 280-1 may be used to selectively mechanically move the grating 282-1 between its first and second positions/states. Each time the grating 282-1 is moved to its second position/state, the grating 282-1 partially reflects any 1310 nm control signal that is present on the optical fiber 225-3, and the reflected signal thus comprises a 1310 nm optical control signal that is injected onto the optical fiber 225-3 that flows in the opposite direction. Amplitude modulation may be used to embed control data in this reflected optical control signal, i.e., the control signal either has a positive amplitude (which occurs when the grating 282-1 is in its second position/state) or an amplitude of zero (which occurs when the grating 282-1 is in its first position/state).

In some embodiments, the backscatter device actuators 280-1 and 280-2 may comprise an ultrasonic acoustic wave generator 280 that includes a piezoelectric material that generates an ultrasonic acoustic wave in response to an electrical control signal. Each ultrasonic acoustic wave generator 280 may be positioned so that the wave output therefrom may be used to move the respective gratings 282-1 and 282-2 from their first position to their second position by, for example, physically stretching, contracting and/or bending the gratings 282. It will be appreciated that the backscatter device actuators 280 may be implemented in other ways including, for example, as other types of piezoelectric devices or using devices such as vibrators or MEMS devices that directly mechanically move or thermally stress the respective gratings 282.

Network data traffic and optical control signals may be simultaneously transmitted over the communications channel 220 as follows. Normal network traffic may be injected onto the communications channel by the optical source 230 via the first MMI-WDM filter 250-1. In the depicted embodiment, the network data traffic may be transmitted using 850 nm optical signals, and may travel along the optical fibers 225 as a multi-mode signal. The network data traffic may be received at the optical receiver 240 via the third MMI-WDM filter 250-3.

The transmitter 260 may be used to inject optical control signals such as interrogation signals, equipment control signals and the like as 1310 nm optical control signals over the communications channel 220 through the control signal port of the first MMI-WDM filter 250-1. These optical control signals may be extracted from the communications channel 220 via the MMI-WDM filter 250-3 to, for example, control equipment located throughout the network or to prompt equipment to transmit sensor data or other information back to a centralized location. The optical transmitter 260 may, in some embodiments, continuously inject a 1310 nm signal onto the communications channel 220. The backscatter device actuators 280 may be used to inject amplitude modulated optical control signals onto the communications channel 220 by selectively moving the backscatter devices 282-1 and 282-2 in order to generate reflected 1310 nm control signals. These reflected control signals may be extracted from the communications channel 220 at the second MMI-WDM filter 250-2 where they are passed to the optical receiver 262-1. In some embodiments, the optical transmitter 260 and the optical receiver 262-1 may be replaced by an optical transceiver and one of the MDI-WDM filters 250-1 or 250-2 may be omitted.

Any of the techniques discussed above with respect to FIG. 1 may be used to avoid interference between control signals (e.g., by having each backscatter device actuator 280 transmit within a different time slot) and/or to identify which devices are associated with the various control signals received at, for example, the centralized location (e.g., by having each backscatter device actuator 280 modulate the control signal at a different frequency). Accordingly, further description of those techniques will not be repeated here.

The embodiment of FIG. 3 allows for two-way control communications, and thus interrogation signals, equipment control signals and the like may be transmitted from the centralized location throughout the fiber optic data network. However, it will be appreciated that in some embodiments the optical transmitter 260 may simply continuously transmit an optical beam at 1310 nm (or other wavelength signal that is used for control communications) that does not include any data, but instead provides an optical signal that may be reflected by the backscatter devices 282 to create optical control signals. It is expected that the embodiment of FIG. 3 will exhibit significantly lower losses than the embodiment of FIG. 2 with respect to the normal (850 nm) network data as the backscatter devices 282 are anticipated to have little impact on the 850 nm network data signals due to the wide separation in wavelength between the control signals and the network data signals. Moreover, if the transmitter 260 is kept on all the time, then the nodes in the network can send control signals to the centralized location at any time, as there will always be a 1310 nm signal to reflect.

It will also be appreciated that the control data that is injected onto the communications channel 220 may be received at both the receiver 262-1 and at the receiver 262-2. In particular, when the backscatter devices 282 are in their second position, some of the energy of the optical signal transmitted by transmitter 260 is reflected at the backscatter devices 282, and this reduction in signal power may be detected by the optical receiver 262-2. Thus, the transmitter 260 may be located at either end of the communications channel 220 as it is possible to detect the control signals injected by the backscatter device actuators 280-1 and 280-2 at both ends of the channel 220 (i.e., by detecting the reflected signal at one end of the communications channel 220 and by detecting the loss in signal power of the signal transmitted at the other end of the communications channel 220).

According to further embodiments of the present invention, the transmitter 260 may be configured to transmit optical signals at a plurality of different wavelengths (i.e., four discrete wavelengths). Each of the backscatter devices 282 may be tuned to a different one of these wavelengths, and thus the wavelength of the received reflected control signal may be used to identify the backscatter device actuator 280 that injected the control signal onto the communications channel 220.

Pursuant to still further embodiments of the present invention, fiber optic data networks are provided that use modulation reflection techniques on the second (or other) harmonics of an optical signal in order to carry control signals over the fiber optic data network at the same time that normal network traffic is supported.

In particular, FIG. 4 is a schematic block diagram of a communications channel 320 of a fiber optic data network 310 according to still further embodiments of the present invention. As shown in FIG. 4, the fiber optic communications channel 320 may comprise, for example, a plurality of optical fibers 325-1 through 325-3. The communications channel 320 further includes a first optical transmitter 330 at one end thereof that injects normal network traffic data signals onto the communications channel 320, and an optical receiver 340 that may be located, for example, at the end of the fiber optic communications channel 320 that is opposite the first optical transmitter 330. In the depicted embodiment, the first optical transmitter 330 is configured to generate, for example, an 850 nm optical signal that may travel along the fiber optic communications channel 320 as a multi-mode signal. However, it will be appreciated that the optical transmitter 330 may transmit other wavelength optical signals.

The communications channel 320 further includes first and second MMI-WDM filters 350-1 and 350-2 that are interposed along the fiber optic communications channel 320. In particular, a first MMI-WDM filter 350-1 may be provided at, for example, a centralized location that may be used to inject optical control signals having a first wavelength (1310 nm, in the example of FIG. 4) onto the communications channel 320. A second MMI-WDM filter 350-2 may also be provided at, for example, the centralized location that may be used to extract optical control signals having a wavelength that is a second harmonic of the first wavelength (655 nm, in the example of FIG. 4) from the communications channel 320. Each of the MMI-WDM filters 350 may be identical to the MMI-WDM filters 50 that are described in more detail above with respect to FIG. 1 (except that they will be tuned to the appropriate wavelengths for which they are intended to operate), and hence further description of the MMI-WDM filters 350 will be omitted. In the embodiment depicted in FIG. 4, the first MMI-WDM filter 350-1 has an 850 nm port (for injecting or extracting the high frequency network data traffic), a 1310 nm port (for injecting optical control signals) and a common port that passes all optical signals, while the second MMI-WDM filter 350-2 has an 850 nm port (for injecting or extracting the high frequency network data traffic), a 655 nm port (for extracting optical control signals) and a common port that passes all optical signals.

As is also shown in FIG. 4, a control signal optical transmitter 360 may be attached to the control signal port of the first MMI-WDM filter 350-1, and control signal optical receiver 362 may be attached to the control signal port of the second MMI-WDM filter 350-2. The optical transmitter 360 may be located at, for example, a centralized location and, in the depicted embodiment, may be used solely to inject a continuous 1310 nm optical signal onto the optical fibers 325 of the communications channel 320. The optical receiver 362 may receive optical control signals that are communicated in the reverse direction along the communications channel 320.

As shown in FIG. 4, a wavelength converter 384 may be interposed along the optical fiber 325-3. The wavelength converter 384 may be implemented as, for example, Periodically Poled Nonlinear (“PPNL”) crystal, a PPNL polymer, a two- or multi-photon fluorescent material, a second harmonic generation microcavity, or by devices that use Raman and/or optical parametric processes to perform wavelength conversion. The wavelength converter 384 may be configured to receive an incident optical signal and convert at least part of that received optical signal to an optical signal having a different wavelength such as, for example, a wavelength that is at or near a harmonic of the wavelength of the incident 1310 nm optical signal. Backscatter devices 382-1 and 382-2 are also provided along the optical fiber 325-2. These backscatter devices 382-1 and 382-2 may operate in the same manner as the backscatter devices 282-1 and 282-2 that are discussed above, except that the backscatter devices 382-1 and 382-2 may be tuned to selectively reflect the optical signals that are converted to the different wavelength that are output from the wavelength converter 384. Backscatter device actuators 380-1 and 380-2 are also provided that may be used to selectively activate the respective backscatter devices 382-1 and 382-2 so that they selectively reflect the optical signal output by the wavelength converter 384.

By way of example, in one embodiment, the wavelength converter 384 may generate a second harmonic of a 1310 nm optical signal that is transmitted by the optical transmitter 360. In particular, the wavelength converter 384 may convert a small portion of the incident 1310 nm optical signal into a 655 nm optical signal. Each of the backscatter devices 382-1 and 382-2 may be “tuned” to 655 nm, which is the second harmonic of the incident 1310 nm optical signal. The backscatter devices 382-1 and 382-2 are each configured so that in a first position they allow 655 nm signals to pass, while in a second position, they act to mostly or completely reflect 655 nm signals. In light of the large wavelength separations, the backscatter devices 382-1 and 382-2 may be designed to substantially pass both 850 nm and 1310 nm optical signals when the backscatter devices 382-1 and 382-2 are in either the first or second positions.

As is further shown in FIG. 4, a backscatter device actuator 380-1, 380-2 is provided adjacent each backscatter device 382-1, 382-2. The backscatter device actuators 380 are configured to, for example, stretch, contract, bend or otherwise move the respective backscatter devices 382-1 and 382-2 between their respective first and second positions. The backscatter device actuators 380-1 and 380-2 may thus be used to selectively cause the respective backscatter devices 382-1 and 382-2 to either allow a selected harmonic of the 1310 nm optical signal (here the second harmonic) to pass or, alternatively, to mostly or completely reflect that harmonic. In this manner, each backscatter device 382-1, 382-2 may be used to inject an optical control signal onto the communications channel 320 under the control of its respective backscatter device actuator 380 by reflecting backward a harmonic of the 1310 nm signal. As with the embodiments of FIGS. 2 and 3, the backscatter device actuators 380 may use amplitude modulation to embed control data in this reflected optical control signal.

The backscatter device actuators 380 may be implemented using the same technologies as the backscatter device actuators 180 and 280 described above. Likewise, the transmitter 360 may be identical to the transmitter 260 that is described above, and the optical receiver 362 may be identical to the optical receiver 262-1 that is discussed above except that it is tuned to receive a different wavelength (namely 655 nm as opposed to 1310 nm). Likewise, the techniques discussed above with respect to the preceding embodiments for avoiding interference between control signals and/or for identifying which devices are associated with the various control signals received at, for example, the centralized location may be used in the embodiment of FIG. 4.

Control signals may be transmitted over the fiber optic data network 310 of FIG. 4 in a manner essentially identical to the fiber optic data network 210 of FIG. 3, except that the reflected control signals are at a harmonic of the 1310 nm signal as opposed to also being at 1310 nm. The control signals in the embodiment of FIG. 4 may be easier detect as there may be a lower noise background at the harmonic wavelength (e.g., at the second harmonic wavelength) and/or because most or all of the harmonic may be reflected. Both network data traffic and optical control signals may be simultaneously transmitted over the communications channel 320.

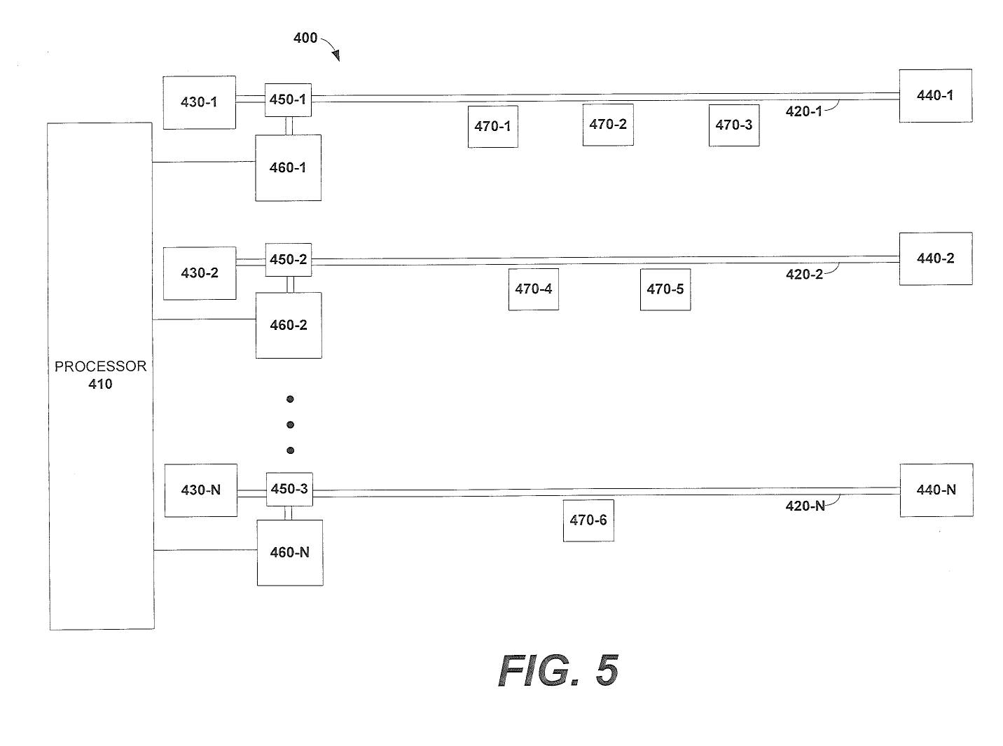

FIG. 5 is a schematic block diagram of a fiber optic data network 400 according to certain embodiments of the present invention. As shown in FIG. 5, the fiber optic data network 400 may include a processor 410 that is located, for example, at a centralized location. The processor 410 may be electrically (or optically) coupled to a plurality of optical transceivers 460-1 through 460-N.

The fiber optic data network 400 further includes a plurality of communications channels 420-1 through 420-N. Network devices 430-1 through 430-N in FIG. 5 may be coupled to a first end of each communications channel 420, and network devices 440-1 through 440-N may be coupled to a second end of each communications channel 420. The first end of the communications channels 420 may or may not be at the centralized location.

Each of the optical transceivers 460 may be coupled to a respective one of the communications channels 420. A control signal injection/extraction device 450 may be included along each of the communications channels 420. The control signal injection/extraction devices 450 may correspond to, for example, the MMI-WDM 50-1 of FIG. 1, the optical circulator 170 of FIG. 2, the MMI-WDMs 250-1 and 250-2 of FIG. 3, or the MMI-WDMs 350-1 and 350-2 of FIG. 4. While an optical transceiver 460 is provided on each of the communications channels 420 of FIG. 5, it will be appreciated that that any of the optical transceivers 460 illustrated in FIG. 5 may be replaced with an optical transmitter and a separate optical receiver and, that in such embodiments, a separate control signal extraction device may be provided on such communications channels as is illustrated in the embodiments of FIGS. 3 and 4.

As is further shown in FIG. 5, one or more control signal injection devices 480 may be located along the central or second end portions of each of the optical communications channels 420 that may be used to inject a control signal onto the communications channel 420. The control signal injection devices 480 may be implemented, for example, as the MMI-WDMs 50-2 and 50-3 of FIG. 1, the backscatter device actuators 180-1 and 180-2 of FIG. 2, the backscatter device actuators 280-1 and 280-2 along with the backscatter devices 282-1 and 282-2 of FIG. 3, or the backscatter device actuators 380-1 and 380-2 along with the backscatter devices 382-1 and 382-2 and the wavelength converter 384 of FIG. 4. Each of the control signal injection devices 480 may be used to inject an optical control signal onto the respective one of the optical communications channels 420 to which it is adjacent. These optical control signals may be transmitted over the optical communications channels 420 at the same time that normal network data is transmitted over the optical communications channels 420. The optical control signals may be extracted from the optical communications links 420 by the control signal injection/extraction devices 450 and provided to the optical transceivers 460. The optical control signals may be passed by the optical transceivers 460 to the processor 410. In this fashion, the nodes may communicate control data in real time to a centralized location using the optical fibers of an existing fiber optic data network.

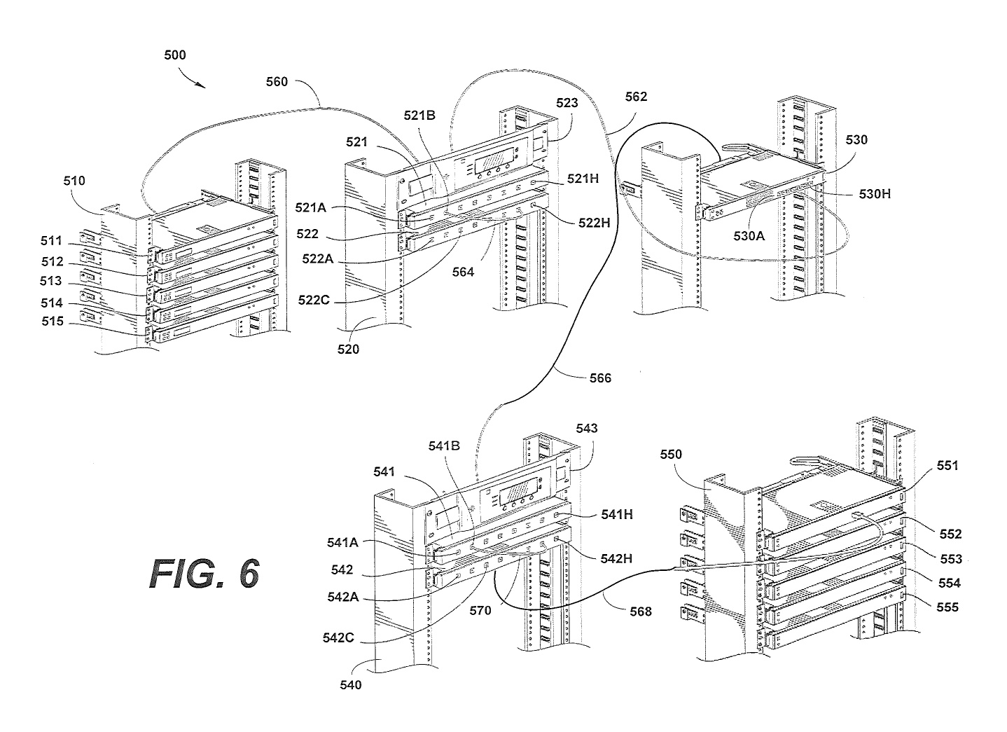

The techniques for coupling optical control signals onto an underlying fiber optic data network that are disclosed herein may be used in a wide variety of different applications. One example application in which the techniques according to embodiments of the present invention may be useful is in tracking patching connections in high speed fiber optic data networks that are used to interconnect computer equipment such as servers, network switches, memory storage systems and the like. These networks are routinely installed in data centers, commercial office buildings, government facilities, educational campuses and the like. The optical couplers according to embodiments of the present invention may be used in such networks to transmit optical control signals that are used to automatically track the connections between the various devices that are interconnected via the fiber optic data network and/or to transmit other control; information such as sensor data and environmental control signals over these fiber optic data networks. FIG. 6 is a schematic diagram of a highly simplified fiber optic data network for a data center or the like in which the techniques according to embodiments of the present invention are used to automatically track the patching connections between network devices in real time.

As shown in FIG. 6, a plurality of network devices 511-515 (which are servers in the example of FIG. 6) may be mounted on a first equipment rack 510. These servers 511-515 may be (indirectly) connected to respective ones of a plurality of connector ports 530A-530H on a rack-mounted network switch 530. The network switch 530 routes packet-switched communications that are received from each server 511-515 toward their intended destination (which may be another network device within the data center or an external device that the server 511-515 is communicating with over an external network such as, for example, the Internet). The network switch 530 likewise routes packet-switched communications that are received from other network devices in the data center and from external sources to the servers 511-515. As is further shown in FIG. 6, a plurality of additional network devices 551-555 (which are memory storage devices in the example of FIG. 6) may be located on a rack 550 elsewhere in the data center. Each memory storage device 551-555 may likewise be (indirectly) connected to the network switch 530. While a total of eleven network devices (namely servers 511-515, network switch 530 and memory storage devices 551-555) are illustrated in FIG. 6 in order to simplify the example, it will be appreciated that in a typical data center, hundreds or thousands of network switches are often provided, and thousands or even tens of thousands of servers, memory storage devices, routers, etc. may be provided.

Changes are routinely made to the network devices in a typical data center, with new devices being added, broken or obsolete devices being removed or replaced, equipment being relocated within the data center, etc. As these changes occur, it often becomes necessary to make temporary and/or permanent changes to the interconnection scheme. As one simple example, if a first memory storage device in a data center is scheduled to be replaced with a new memory storage device, servers and other computer equipment that use the first memory storage device may need to be temporarily connected to a second memory storage device until such time as the new memory storage device may be installed, configured, tested and brought online. In order to simplify the process of changing the connections between devices in a data center, the communications lines used to interconnect the servers, memory storage devices, routers and other computer equipment to each other and to external communication lines are typically run through sophisticated patching systems.

In the simplified example of FIG. 6, the patching system comprises a first set of (two) patch panels 521, 522 that are mounted on an equipment rack 520, and a second set of (two) patch panels 541, 542 that are mounted on an equipment rack 540. In the simplified embodiment of FIG. 6, each of the patch panels 521, 522, 541, 542 includes eight connector ports A-H (e.g., the connector ports on patch panel 521 are connector ports 521A-521H) such as, for example, SC, LC and/or Multi-fiber Push On (“MPO”) fiber optic connector ports. Only a few of the patch panel and network switch connector ports are labeled in FIG. 6 to simplify the drawing, but it will be appreciated that the connector ports on each patch panel 521, 522, 541, 542 are aligned in a row in alphabetical order (e.g., connector port 521A is on the left, connector port 521B is just to the right of connector port 521A, connector port 521C is just to the right of connector port 521B, etc.).

Focusing first on the upper portion of FIG. 6, it can be seen that a first set of patch cords 560 (only one patch cord 560 is shown in FIG. 6 to further simplify the drawing) is provided that connect each server 511-515 to the back side of a respective one of the connector ports 521A-521H on the first patch panel 521. A second set of patch cords 562 (only one patch cord 562 is shown in FIG. 6) is provided that connect the back side of each connector port 522A-522H on the second patch panel 522 to respective ones of the connector ports 530A-530H on the network switch 530. A third set of fiber optic cables 564 is provided that extend between the connector ports 521A-521H on patch panel 521 and connector ports 522A-522H on patch panel 522 (only one patch cord 564 is shown in FIG. 6). By choosing which connector ports 521A-521H and 522A-522H to plug each end of a particular patch cord 564 into, a technician can connect each of the servers 511-515 to any of the connector ports 530A-530H on network switch 530.

As shown in the lower portion of FIG. 6, a fourth set of patch cords 566 (only one patch cord 566 is shown in FIG. 6) is provided that connect the back side of each connector port 541A-541H on patch panel 541 to a respective one of a plurality of connector ports (not visible in FIG. 6) that are located on the back side of the network switch 530. A fifth set of patch cords 568 (only one patch cord 568 is shown in FIG. 6) is provided that connect the back side of each connector port 542A-542H on the patch panel 542 to respective ones of the memory storage devices 551-555. A sixth set of fiber optic patch cords 570 is provided that extend between the connector ports 541A-541H on patch panel 541 and connector ports 542A-542H on patch panel 542 (only one patch cord 570 is shown in FIG. 6). By choosing which connector ports 541A-541H and 542A-542H to plug each end of a particular patch cord 570 into, a technician can connect each of the memory storage devices 551-555 to any of the second plurality of connector ports (not visible in FIG. 6) that are provided on the back side of the network switch 530.

As is further shown in FIG. 6, a rack manager 523 is provided, for example, on the same equipment rack as the patch panels 521, 522, and a rack manager 543 is provided, for example, on the same equipment rack as the patch panels 541, 542. The rack manager 523 may be in communication with processors (not shown) that may be provided on patch panels 521, 522, and the rack manager 543 may be in communication with processors (not shown) that may be provided on patch panels 541, 542. A system administrator computer (not shown) may also be provided that is in communication with the rack managers 523, 543. The rack managers 523, 543 and/or the system administrator computer may control operations of the intelligent patching system included in network 500 so that the connections of the patch cords 564 between connector ports 521A-521H and connector ports 522A-522H and the connections of the patch cords 570 between connector ports 541A-541H and connector ports 542A-542H are automatically tracked in real time and logged in a database each time a technician changes the connectivity of the end devices in the fiber optic data network 500 by rearranging the connector ports that the patch cords 564 and 570 are plugged into. As will be discussed below, the control signal injection/extraction devices and techniques according to embodiments of the present invention may be used to inject and extract intelligent patching control signals onto and from the cabling of the fiber optic data network to automatically track these patching connections.

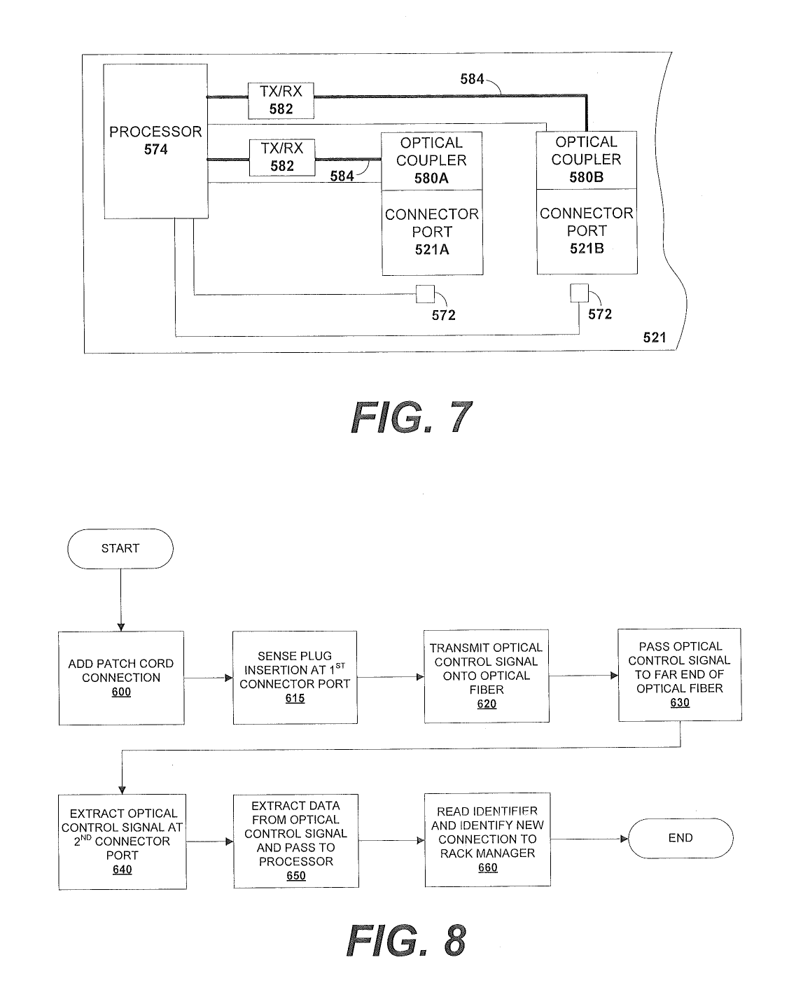

FIG. 7 is an enlarged, cut-away, schematic block diagram that illustrates various of the components that are included on one example embodiment of the fiber optic patch panel 521 of FIG. 6. The fiber optic patch panels 522, 541 and 542 may be identical to the patch panel 521, and hence will not be discussed further. The fiber optic patch panel 521 includes connector ports 521A-521H, only two of which are visible in the enlarged view of FIG. 7. Each of the connector ports 521A-521H may (optionally) include an associated plug insertion/removal sensor 572. These plug insertion/removal sensors 572 are configured to detect each time a fiber optic patch cord is inserted into, or removed from, the front side of the respective connector ports 521A-521H. Each of the plug insertion/removal sensors 572 (if provided) may be electrically connected to a processor 574. In some embodiments, each plug insertion/removal sensor 572 may continuously transmit a control signal to the processor 574, with a voltage level of the control signal indicating either the presence (e.g., a high voltage level) or absence (e.g., a low voltage level) of a plug in the connector port 521A-521H with which each plug insertion/removal sensor 572 is associated. The plug insertion/removal sensors 572 may be implemented using, for example, mechanical sensors, optical sensors, electrical sensors, magnetic sensors, wireless technology (e.g., RFID tags, serial ID tags, etc.) or any other technology that may be used to detect when a plug is inserted into, or removed from, one of the connector ports 521A-521H.

The patch panel 521 further includes a plurality of control signal injection/extraction devices 580A-580H (only control signal injection/extraction devices 580A and 580B are visible in FIG. 7). The control signal injection/extraction devices 580A-580H may be, for example, any of the control signal injection/extraction devices according to embodiments of the present invention that are discussed herein such as, for example, the MMI-WDM 50-1 of FIG. 1. An optical transceiver 582 and an optical transmission path 584 may be provided adjacent to each of the control signal injection/extraction devices 580A-580H. Each control signal injection/extraction device 580A-580H may be used to inject an optical control signal that is generated by its associated optical transceiver 582 onto an optical fiber of a patch cord 564 (see FIG. 6) that is plugged into the connector port 521A-521H that is associated with the control signal injection/extraction device 580A-580H, and/or may be used to extract optical control signals from the optical fiber of the patch cord 564 and provide the extracted control signal to the associated optical transceiver 582.

As is further shown in FIG. 7, the processor 574 is in communication with the control signal injection/extraction devices 580A-580H and with the optical transmitter/receivers 582. The processor 574 may control the control signal injection/extraction devices 580A-580H and the optical transceivers 582 to cause them to inject an optical control signal onto optical fibers of the patch cords 564 that are plugged into the connector ports 521A-521H and/or may receive optical control signals that are extracted from the optical fibers of the patch cords 564 via the control signal injection/extraction devices 580A-580H.

Examples of ways in which the fiber optic data network 500 may be operated to automatically track patching connections therein will now be described with reference to FIGS. 6-7 and the flow chart of FIG. 8. As shown in FIG. 8, operations may begin with a fiber optic patch cord 564 being coupled between a connector port (e.g., connector port 521B) on the first fiber optic patch panel 521 and a connector port (e.g., connector port 522G) on the second fiber optic patch panel 522 (block 600). A plug insertion/removal sensor 572 that is associated with the connector port 521B senses the insertion of the fiber optic patch cord 564 into connector port 521B, and sends a control signal to the processor 574 on patch panel 521 that indicates that this plug insertion has occurred (block 610).

In response to the plug insertion control signal, the processor 574 controls the control signal injection/extraction device 580B and the optical transceiver 582 that are associated with connector port 521B to generate an optical control signal that is injected onto an optical fiber of the patch cord 564 that was plugged into connector port 521B (block 620). In this particular example, it will be assumed that the injected optical control signal includes a unique identifier embedded therein that identifies the connector port (i.e., connector port 521B of patch panel 521) at which the optical control signal was injected onto the optical fiber. The injected optical control signal will pass to the far end of the optical fiber which, in the present example, is plugged into connector port 522G of patch panel 522 (block 630).

As shown in FIG. 8, the control signal injection/extraction device 580 that is associated with connector port 522G detects, and then extracts, the optical control signal from the optical fiber of the patch cord 564, and passes the extracted optical control signal to the optical transceiver 582 (block 640). The optical transceiver 582 extracts the data from the received optical control signal and passes this data to the processor 574 on patch panel 522 (block 650). The processor 574 reads the unique identifier of connector port 521B on patch panel 521 from the optical control signal and then notifies its rack manager 523 that a new patch cord connection has been identified that extends between connector port 521B on patch panel 521 and connector port 522G on patch panel 522 (block 660). In this fashion, the fiber optic data network 500 may use optical control signals that are transmitted over the optical fibers of the underlying fiber optic data network 500 to automatically track patching connections.

The fiber optic data network 500 may use the plug insertion/removal sensors 572 to detect the removal of patch cords, as these sensors 572 will notify the processors 574 on their respective patch panels 521, 522 each time an end of a fiber optic patch cord is removed from the connector ports thereon. Upon being notified of such plug removals, the rack manager 523 may delete the patch cord connection associated with the connector ports at issue from the database.

While the embodiments described with respect to FIGS. 6 and 7 include plug insertion/removal sensors 572, it will be appreciated that these sensors 572 may be omitted in other embodiments. In such embodiments, the intelligent patching system may, for example, periodically inject optical control signals serially at every connector port for injection onto any patch cord inserted therein in order to map the patch cord connections.

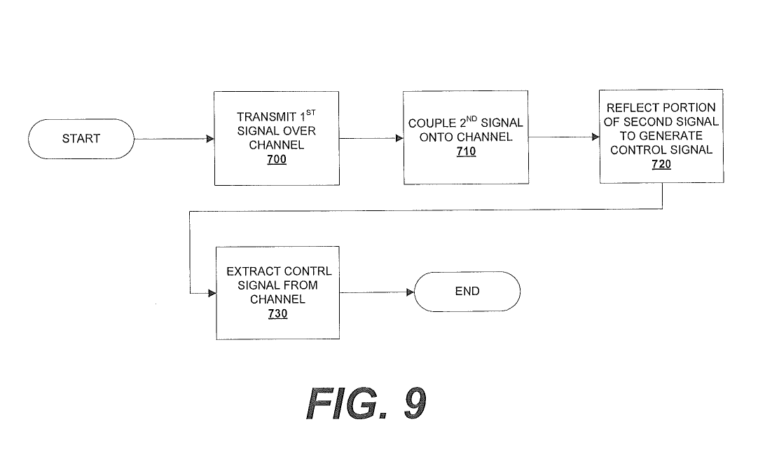

FIG. 9 is a flow chart illustrating methods of transmitting control signals over a communications channel of a fiber optic data network according to certain embodiments of the present invention. As shown in FIG. 9, operations may begin with the transmission of a first optical signal that has a first wavelength from a first network device to a second network device over the communications channel of the fiber optic data network (block 700). Next, a second optical control signal that has a second wavelength that is different than the first wavelength may be coupled onto the communications channel (block 710). This may be accomplished, for example, using a wave division multiplexer. Next, a portion of the second optical signal may be at least partially reflected to generate a control signal (block 720). A backscatter device may be used to reflect the portion of the second optical signal. Finally, the optical control signal may be transmitted along the communications channel and then extracted from the communication channel at an intended destination (block 730).

Herein reference is made to various optical data signals and optical control signals. It will be appreciated that these optical signals may be within or outside of the visible spectrum.

The present invention has been described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed above can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the above description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

Certain embodiments of the present invention have been described above with reference to the flowcharts of FIGS. 8 and 9. It will be understood that some blocks of the flowchart illustrations may be combined or split into multiple blocks, and that the blocks in the flow chart diagrams need not necessarily be performed in the order illustrated in the flow charts. It will also be understood that in some embodiments of the present invention the operations identified in some of the blocks in the flowcharts of FIGS. 8 and 9 may be omitted.

It will be appreciated that each of the above-described embodiments may be combined in different ways to create a plurality of additional embodiments

In the drawings and specification, there have been disclosed typical embodiments of the invention and, although specific terms are employed, they are used in a generic and descriptive sense only and not for purposes of limitation, the scope of the invention being set forth in the following claims.

1. A fiber optic data network, comprising:
a first network device that includes a first optical transmitter that is configured to transmit an optical signal having a first wavelength;
a second network device;
a fiber optic communications channel that provides a data connection between the first network device and the second network device;
a second optical transmitter that is configured to transmit an optical signal having a second wavelength that is different from the first wavelength; and
a coupling device that is configured to inject the signal having the second wavelength that is output by the second optical transmitter onto the fiber optic communications channel.

2. The fiber optic data network of claim 1, wherein the coupling device comprises a first wave division multiplexer.

3. The fiber optic data network of claim 2, further comprising a second wave division multiplexer that is remote from the first wave division multiplexer and that is configured to inject an optical control signal onto the fiber optic communications channel.

4. The fiber optic data network of claim 2, further comprising a backscatter device that is tuned to the second wavelength and a backscatter device actuator that is configured to selectively activate the backscatter device so as to selectively reflect a portion of the optical signal having the second wavelength.

5. The fiber optic data network of claim 4, wherein the backscatter device actuator is configured to generate an amplitude modulated control signal by causing the backscatter device to selectively reflect the portion of the optical signal having the second wavelength.

6. The fiber optic data network of claim 5, further comprising a second wave division multiplexer that is interposed on the fiber optic communications channel and a receiver that is coupled to an output of the second wave division multiplexer.

7. The fiber optic data network of claim 2, further comprising a wavelength converter that is configured to generate an optical signal at a third wavelength that is different than the second wavelength, a backscatter device that is tuned to the third wavelength and a backscatter device actuator that is configured to selectively activate the backscatter device so as to selectively reflect at least a portion of the optical signal at the third wavelength.

8. The fiber optic data network of claim 7, wherein the backscatter device actuator is configured to generate an amplitude modulated control signal by causing the backscatter device to selectively reflect at least a portion of the optical signal at the third wavelength.

9. The fiber optic data network of claim 8, wherein the third wavelength is a second harmonic of the second wavelength.

10. The fiber optic data network of claim 1, wherein the first wavelength and the second wavelength are separated by at least 50 nanometers.

11. The fiber optic data network of claim 4, wherein the backscatter device actuator comprises an ultrasonic acoustic modulator.

12. The fiber optic data network of claim 2, wherein the optical control signal comprises sensor data.

13. The fiber optic data network of claim 4, wherein the backscatter device comprises a grating, and the backscatter device actuator comprises a device that selectively imparts a stress on the grating that tunes the grating to reflect signals at the second wavelength.

14. A method of communicating over a communications channel that includes one or more optical fibers, the method comprising:
transmitting a first optical signal that has a first wavelength from a first network device to a second network device over the communications channel;
coupling a second optical signal that has a second wavelength that is different from the first wavelength onto the communications channel; and
reflecting a portion of the second optical signal with a backscatter device to generate an optical control signal that is transmitted along the optical fiber simultaneously with the first optical signal.

15. The method of claim 14, further comprising using the backscatter device actuator to selectively activate the backscatter device so as to amplitude modulate the optical control signal.

16. The method of claim 15, further comprising using a wave division multiplexer to extract the optical control signal from the communications channel.

17. A method of communicating over a fiber optic communications channel, the method comprising:
transmitting an optical data signal that has a first wavelength from a first network device to a second network device over the fiber optic communications channel;
reflecting a portion of the optical data signal with a backscatter device actuator to generate an optical control signal that is transmitted along the fiber optic communications channel simultaneously with the optical data signal; and
coupling the optical control signal from the fiber optic communications channel to an optical receiver using an optical circulator that is interposed along the fiber optic communications channel.

18. The method of claim 17, wherein reflecting a portion of the optical data signal with a backscatter device actuator to generate an optical control signal that is transmitted along the fiber optic communications channel simultaneously with the optical data signal comprises using the backscatter device actuator to selectively stress the fiber optic communications channel in order to reflect the optical data signal in a manner that amplitude modulates the optical control signal.

19. The method of claim 18, wherein the backscatter device comprises a piezoelectric device or a MEMS device.

20. (canceled)
